(19) United States
(12) Patent Application Publication
(10) Pub. No.: US 2003/0123628 A1
(43) Pub. Date: Jul. 3, 2003

(54) METHOD AND APPARATUS FOR DETERMINING BILLING RATES FOR COMMUNICATION SERVICES

(76) Inventor: JEFFREY RHODES, REDMOND, WA (US)

Correspondence Address: KENYON & KENYON, 1500 K STREET, N.W., SUITE 700, WASHINGTON, DC, 20005, US

(21) Appl. No.: 09/135,344

(22) Filed: Aug. 17, 1998

(51) Int. Cl. H04M 15/00

(52) U.S. Cl. 379/114.01; 379/114.05

(57) ABSTRACT

A method and apparatus provide for adjustable billing of different subscriber uses of network resources. A network monitors quantitative characteristics of a connection and assesses the type of information which is being transported in the connection. Once the type of information is identified, a billing rate commensurate with that type of information can be applied to the process for billing with regard to that connection.

### BACKGROUND OF THE PRESENT INVENTION

The present invention relates to a method and apparatus for determining billing rates for communication services. More particularly, the invention relates to detecting which one of a plurality of services a user is utilizing over a connection medium and adjusting billing rates accordingly.

Telephone lines have long been utilized for providing different types of communication services for subscribers. Increasingly telephone lines are being utilized for data transmission rather than voice transmission. As an example, it is common for wide area network access providers to enable access to the Internet. These Internet Service Providers (ISPs) create telephone connections over telephone lines which are dominated by data transmission rather than voice transmissions. While a typical voice call could last on the average of a few minutes, a data call often lasts much longer. Long data calls tie up limited network resources, for example the switch fabric of a network, and require a more costly line-to-trunk ratio at a voice-preferred switch. This is especially true in view of ISPs that are charging customers a flat rate for unlimited usage. While voice communications may utilize a relatively small amount of the network's resources on average, since the telephone network has been appropriately designed to handle voice calls, long data calls are likely to pose a greater consumption of network resources on average.

An example of a configuration representative of this problems is illustrated in FIG. 1. A residential user may be offered a new access service, either via wireless or cable, that requires a given frequency spectrum 101 to be devoted to a digital signal that is transmitted to the access provider. This new access service must be able to replace the existing plain old telephone service (POTS) such that the user's existing analog equipment is still able to function in the same manner that is familiar to the user. This means that analog modems, analog faxes and normal analog telephones must operate within the frequency spectrum 102 of the digital signal that provides the new access service. A portion of the access service's frequency spectrum can be allocated to the support of existing analog devices such as telephone 110 and analog fax and analog modem 111, while the remainder of frequency spectrum 103 is allocated to the support of purely digital devices 112. Either the user chooses to utilize the portion of 101 that is devoted to analog devices (102) which will be split for transmission to the voice telephone network, or the user chooses to utilize the portion of 101 that is devoted to digital-only devices (103), which will be split for transmission to a more efficient data network. As can be seen, the ISP destination is obtained in either case but depending on the type of equipment the user chooses to initiate a call, either the voice-preferred network is selected or the data-preferred network is selected.

As it turns out, analog modems and analog faxes are inherently inefficient because they require the conversion of a digital signal to an analog signal. Great efficiencies can be realized when the original digital signal is able to remain purely digital as it is transported on a data-preferred network. From the user's point of view, there is no incentive to discontinue the use of the inefficient analog dependent devices. Thus the cable or wireless residential access provider must allocate more of their available frequency spectrum to support these analog dependent devices, which on average continue to burden an otherwise voice-preferred telephone network. When a new digital-only device is made available to the user, such that this new device is able to provide methods and techniques that accomplish the same end results for the user that were previously only attainable with analog devices, such as access to an ISP, then the wireless or cable access provider could allocate more of the available frequency spectrum to purely digital devices and therefore less frequency spectrum to analog dependent devices, thus achieving more efficient use of both voice-preferred and data-preferred network resources. A wireless or cable access provider could create an incentive for users to select the more efficient methods and techniques by charging a higher price for using the inefficient analog dependent devices. Unfortunately, today's billing systems at telephone network nodes have no way to distinguish the type of analog equipment that is being used for a given call's duration.

It would be advantageous if a technique existed by which the wireless or cable access provider could monitor the type of use being provided by the network resources and could be appropriately compensated for varying degrees of services carried over the network resources, within the bounds of a single call.

### SUMMARY OF THE INVENTION

In accordance with an embodiment of the present invention, characteristics of a communication connection are detected. The characteristics are quantitative and one such characteristic may be, for example, the energy level of the signal transported by the network resources to effect the desired connection. The detected quantitative characteristic is used as a parameter for identifying a type of service for which the network connection is being used. Once the type of service is identified, then the network provider can select a billing rate commensurate with the service for which the network is being used. The billing rate can then be used to generate billing charges for the user that elects to take advantage of the network's resources for providing a particular type of service.

Examples of types of service include voice services, high-speed data services and fax/modem data services. The network provider can select an appropriate level of granularity for distinguishing between services in accordance with the quantitative parameter that is to be monitored. As a consequence, the network provider can receive greater compensation for network usage which results in higher burdens on the network.

### BRIEF DESCRIPTION OF THE DRAWINGS

FIG. 1 illustrates an example of a configuration with which the present invention may be employed.

FIG. 2 illustrates a block diagram example of a network node employing an embodiment of the present invention.

FIG. 3 illustrates a flow chart for performing a method in accordance with an embodiment of the present invention.

### DETAILED DESCRIPTION

In accordance with an embodiment of the present invention, the network service provider detects the level of communication service that the subscriber is using over the network resources. For example, the network resources can include one or more links that are common to a number of subscribers and thus must be shared by the subscribers. Similarly, the network resources can include switches that control the routing of connections between terminals via a plurality of links. In accordance with an embodiment of the present invention, the network provider monitors the transmission(s) occurring during the course of a connection that was established by the network at the request of a subscriber. At least one quantitative parameter of the transmission is detected and used as a reference for determining which layer of service, among a plurality of layers presenting different burdens to the network, is being employed to process the connection in question.

As an example, presently an established voice call between two users can be diverted to analog modems and vice-versa, without disconnection of the call. Existing billing systems are only able to charge a single price for the duration of that entire call regardless of whether there has been such a switch in usage type. The embodiment of the present invention enables the provider to charge one price for the portion of the call's duration that is devoted to transporting analog voices within the telephone network and to charge another price for the duration of the call that transports the digital signals of analog modems or other data intensive devices within the telephone network. By charging more for the convenience of using analog modems for Internet access within the telephone network, providers could persuade users to seek new methods and techniques for Internet access via a more efficient, alternate data network. Both the telephone network and the data network use the same digital transmission equipment (104) but a connection established via the telephone network requires continuous transmission to sustain the connection, while a connection made via the data network may only require transmission intermittently, hence the data network connections can be more efficient overall.

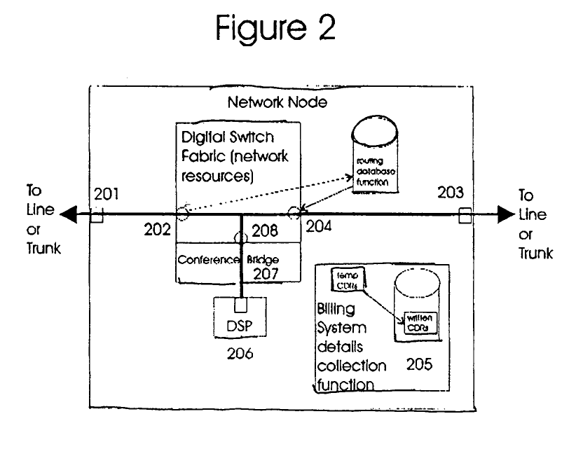

FIG. 2 illustrates a block diagram of a telephone network node arrangement which may be used to achieve an embodiment of the present invention within the telephone network. In this network node configuration, there is a port 201 that receives a call request. Digital Switch Fabric network resource 202 is assigned to port 201. A connection request is made to the routing database function that determines that port 203 is available to serve the call's destination. A temporary Call Detail Record (CDR) is created by the Billing System details collection function (205) to accumulate the data that is relevant to a call's duration. A new detail within the CDR, a “call characteristic” detail, is initially empty. If the call is disconnected before the call is answered, then this detail will remain empty, as will the “answer time” detail, while the “disconnect time” detail would be filled with an appropriate time stamp. When a call is answered, the temporary CDR's “answer time” detail is filled with an appropriate time stamp, and the embodiment of the invention simultaneously causes a Digital Signal Processor (DSP) 206, to attach to a Conference Bridge 207, using network resource 208, to monitor the digital values in both directions that are transported between network resources 202 and 204.

The DSP's software provides a reliable, quantitative algorithm to characterize the analysis of the monitored digital transmission. For example, the DSP could use the energy equivalent of consecutive digital values that would result should the transmitted digital values be converted to analog. In view of the fact that it is known in telecommunications to calculate such a quantity using traveling root mean squares to control the operation of echo cancelers in a network, one of ordinary skill in the art should be able to develop the appropriate DSP software to perform the desired analysis. The transported digital values of a voice conversation between humans is characterized by very low analog energy equivalents. The transported digital values of purely digital information exchanged between ISDN data equipment is characterized by a very high analog energy equivalent. So-called 56K analog modems are limited by FCC regulation to transport digital values that equate to an analog energy equivalent, which is achieved in one direction only, that is slightly less than the analog energy equivalent of the purely digital ISDN data equipment. Analog modems and analog faxes inherently transport digital values within a network node that equate to analog energy equivalents that are naturally less than the maximum allowed by the FCC and, unlike so-called 56K analog modems, their analog energy equivalents are roughly equal in both directions.

Alternatively, the linearity (slope) of consecutive digital values could be another factor for determining service usage.

Regardless of the DSP algorithm that is used to characterize the differences between the digital values transported in both directions for non-voice usage, versus the digital values transmitted by voices, the derived characteristic is reported to the Billing System details collection function (205). When a call's characteristic is determined to have changed before the call has been disconnected, then the existing temporary CDR is made permanent in the Billing System's database of written CDRs. The old characteristic detail, with an appropriate “change characteristic time stamp” detail, helps indicate the amount of time that the old characteristic was used. A new temporary CDR is duplicated to replace the written CDR and is thus able to carry forward details such that the new “answer time” detail may be replaced by the last “change characteristic time” detail, etc. Generally, calls will not change characteristics, but since this is possible, the DSP must monitor and report the call's characteristic at regular intervals throughout the entire call's duration. The Billing System must be able to accommodate more than a single CDR to account for the entire duration of a call. Temporary CDRs are always made permanent and written to disk without replacement when a call is ultimately disconnected.

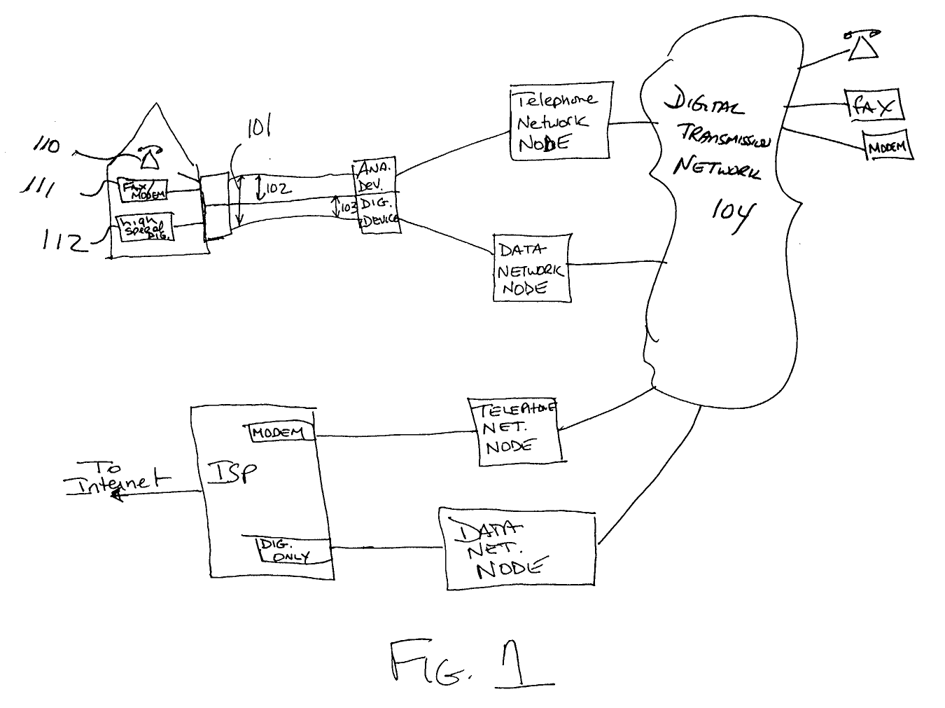

In one version of the invention, the monitoring could occur at the very beginning of transmissions across the established connection, for example at the cable/wireless access in the home, or even at the digital signal splitter at the access provider (see FIG. 1). A more accurate assessment of costs for usage of network resources might be attained by periodically checking the quantitative parameter of the call connection, for instance the analog energy level equivalent, and adjusting the billing rates when the network resources appear to be carrying different types of information. For example, it is possible that a connection that begins as a voice connection could be transformed into a high speed data connection and it would be possible using the present invention to detect this change and to apply different billing rates for the two different time intervals where there were voice and data communications.

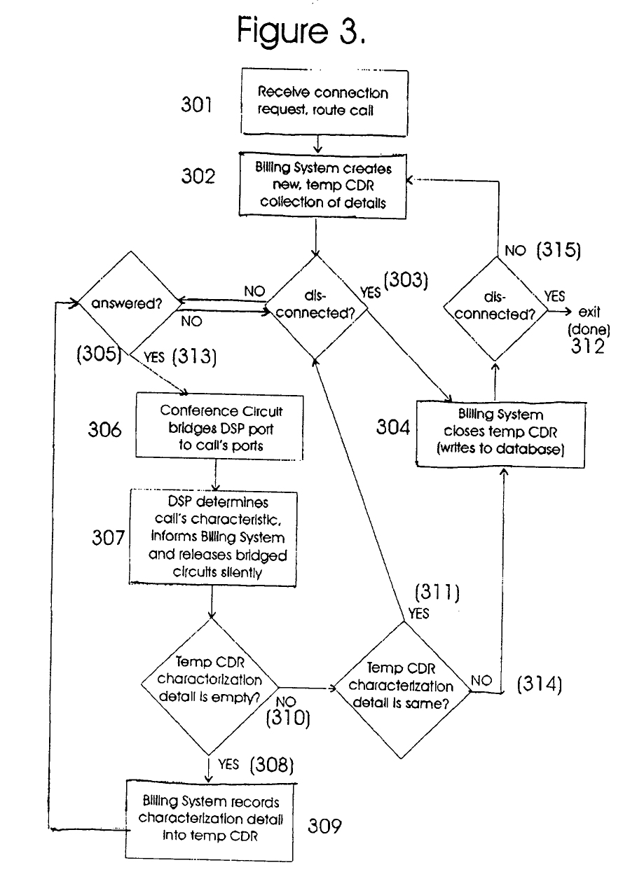

FIG. 3 provides a flow chart that describes an embodiment of operating the present invention within a telephone network node. The node receives a connection request and the call is routed to the next network node, step 301. Before the call is completed, the local node's Billing System creates a new, temporary Call Detail Record (CDR), step 302. The temporary CDR collects information details that pertain to the pricing of a call, e.g., was the call answered, how long was the call answered, was the call used for voice or data, etc. When the call is disconnected (303), there are no more details to collect, so the local node's Billing System closes the temporary CDR and makes the information permanent by writing the CDR to a database in step 304 and (312). If instead the call is answered before it is disconnected (305), then a Conference Circuit bridges a Digital Signal Processor (DSP) to the call's network resources that sustain the continuous transmission of digital values that is required within the telephone network, in step 306. While silently monitoring the digital values that are transmitted in both directions, the DSP determines the call's characteristics during a sampling interval and then releases the bridged network resource circuits in order to repeat the same analysis on another call, in step 307. When a temporary CDR is first created, the “call characteristic” detail is initially empty, so the DSP determined characteristic must be recorded in the “call characteristic” detail (308), in step 309. On the other hand (310), if the DSP determined characteristic is the same (311), the “call characteristic” detail has already been recorded in the temporary CDR, yet the call may have subsequently become disconnected (303) which causes step 304 and (312). On the other hand, if the call has not been disconnected, it remains answered (313) and the process repeats. Since a voice call can be diverted to analog modems to become a data call, (314) may occur before the call is disconnected, which causes step 304 to make the temporary CDR permanent and also causes step 302 to create a new temporary CDR with an empty “call characteristic” detail, perhaps carrying forward some of the details from the previous temporary CDR. The embodiment of the invention at a telephone network node allows the local Billing System to create multiple, permanent CDRs for the duration of a single call, whereas Billing Systems that lack the invention are limited to a single CDR that lacks any details with respect to the call's use.

The present invention thereby provides a network with the capability of distinguishing between different uses of the network facilities and selecting a charge rate commensurate with the impact that the different types of communication services have on the network resources. For example, where the network facilities are typically considered part of a voice-preferred network, the present invention allows the network provider to charge a user more for data use over that network rather than voice use over that network. The present invention effectively does this by detecting a quantative parameter of the transmission along the network resources. This detection occurs without any analysis of the content of the communication. Thus, there is no “wire tapping” of the communication, that is the transmission contents themselves remain confidential. Instead, the present invention detects characteristics of those transmissions which indicate the level of service or the level of network resources which the user is consuming.

While this invention has been described with specific embodiments thereof, it is evident that many alternatives, modifications, and variations will be apparent to those skilled in the art. Accordingly, the preferred embodiments of the invention as set forth herein are intended to be illustrative, not limiting. Various changes may be made without departing from the spirit and scope of the invention.

What is claimed is:

1. A method for billing a telephone call, the method comprising the steps of:
determining whether a telephone call is transmitting voice or data;
billing a customer a first rate if said call is transmitting voice; and
billing a customer a second rate if said call is transmitting data.

2. A method for determining a billing rate for a transmission along a communication path that is capable of providing a plurality of communication services, the method comprising the steps of:
detecting a quantitative characteristic regarding the transmission;
determining, based on said detected quantitative characteristic, which one of the plurality of communication services is being provided to support the transmission; and
selecting as the billing rate a billing rate corresponding to the communication service determined to be provided by the communication path.

3. The method of claim 2 wherein said quantitative characteristic relates to a signal energy equivalent level of the digital value of the transmission.

4. The method of claim 3 wherein the plurality of communication services include voice calls and data calls.

5. The method of claim 3 wherein the communications path comprises a voice bearer service path and the plurality of communication services include voice calls and data calls.

6. The method of claim 5 wherein the data calls include high-speed digital data calls and fax/modem data calls.

7. A method for tracking different communication services over a common transmission medium, the method comprising the steps of:
monitoring a communication on the common transmission medium;
detecting a quantitative characteristic regarding the communication; and
determining, based on the detected quantitative characteristic, a level of service being used on the common transmission medium.

8. The method of claim 7 wherein said quantitative characteristic relates to a signal energy equivalent level of the digital value of the transmission.

9. The method of claim 8 wherein the different communication services include voice calls and data calls.

10. A method for providing adjustable rate billing for use of a communication medium, the method comprising the steps of:
monitoring a transmission on the communication medium;
detecting a type of information conveyed in the monitored transmission; and
selecting a billing rate to be associated with the transmission based on said detected type of information.

11. The method of claim 10 wherein said step of detecting includes the substeps of:
determining a signal energy equivalent level of the digital value of the monitored transmission; and
identifying an information type from a plurality of types based on the detected energy level.

12. The method of claim 11 wherein the communication medium comprises a voice bearer service.

13. The method of claim 12 wherein the plurality of information types include voice and data.

14. A method for providing adjustable rate billing for use in a telephone service medium, the method comprising the steps of:
monitoring a call on the telephone service medium;
during a first time interval detecting a first type of information conveyed in the monitored call;
during a second time interval detecting a second type of information conveyed in the monitored call;
applying a first billing rate to said first time interval in a billing calculation for the call; and
applying a second billing rate, different from said first billing rate, to said second time interval in a billing calculation for the call.

15. The method of claim 14 wherein said first type of information and said second type of information are selected from a group including voice and digital data and said first type of information differs from said second type of information.

16. The method of claim 15 wherein said step of detecting said first type of information comprises the substeps of:
determining a signal energy level equivalent of signals traversing the medium during the first time interval; and
classifying the communication that occurs during said first interval of the call based on the determined energy level.
